(19) United States
(12) Patent Application Publication
(10) Pub. No.: US 2004/0141221 A1
(43) Pub. Date: Jul. 22, 2004

(54) Two-dimensional optical scanner, and image display system

(76) Inventors: Takayoshi Togino, Tokyo (JP); Mitsunori Kubo, Tokyo (JP)

Correspondence Address: Kenyon and Kenyon, 1500 K Street N.W., Suite 700, Washington, DC, 20005, US

(21) Appl. No.: 10/602,071

(22) Filed: Jun. 24, 2003

(30) Foreign Application Priority Data
Jul. 9, 2002 (JP) 2002-199872

(51) Int. Cl. G02B 26/08; G02B 5/04

(52) U.S. Cl. 359/212; 359/833

(57) ABSTRACT

The invention relates to a two-dimensional optical scanner in which distortions upon scanning can be reduced in simplified construction and a compact, energy-saving image display system using the same. The two-dimensional optical scanner comprises a light source 10, a scanner unit of gimbal structure for scanning a light beam therefrom in a two-dimensional direction and a scanning optical system 20 comprising a non-rotationally symmetric surface having an action of correction of a distortion upon scanning of the scanned light beam. The scanning optical system 20 comprises a decentered prism comprising an entrance surface 24, a first reflecting surface 23, a second reflecting surface 22 and an exit surface 21. The respective surfaces of the prism are located such that in that prism, a light beam from the entrance surface 24 toward the first reflecting surface 23 crosses a light beam from the second reflecting surface 22 toward the exit surface 21. At least one of the entrance surface 24, first reflecting surface 23, second reflecting surface 22 and exit surface 21 comprises a non-rotationally symmetric surface.

This application claims benefit of Japanese Application No. 2002-199872 filed in Japan on Jul. 9, 2002, the contents of which are incorporated by this reference.

### BACKGROUND OF THE INVENTION

The present invention relates generally to a two-dimensional optical scanner for image formation and an image display system using the same, and more particularly to an optical scanner having a gimbal structure with reduced distortions upon scanning and an image display system using the same.

The applicant has come up with an optical scanner in JP-A's 2001-174740, 2001-281583, etc. More specifically, JP-A 2001-174740 discloses a small-format scanner designed such that the center beam of incident beams is substantially in line with the center beam of emergent beams, and JP-A 2001-281583 shows a small-format optical scanner comprising a combination of a single two-dimensional reflecting mirror with a decentered prism.

### SUMMARY OF THE INVENTION

Thus, the present invention provides a two-dimensional optical scanner, comprising in combination:

a light source,

a scanner unit for scanning a light beam from said light source on the surface to be scanned in a two-dimensional direction, and

a scanning optical system having a non-rotationally symmetric surface, wherein:

said scanner unit has a gimbal structure, and

said scanning optical system comprises a decentered prism having an entrance surface through which a light beam scanned by said scanner unit enters said prism, at least one reflecting surface for allowing a light beam entered from said entrance surface into said prism to be reflected in said prism and an exit surface through which a light beam reflected at said second reflecting surface leaves said prism, wherein at least one of said entrance surface, said reflecting surface and said exit surface comprises a non-rotationally symmetric surface.

The present invention also provides a two-dimensional optical scanner, comprising in combination:

a light source,

a scanner unit for scanning a light beam from said light source on the surface to be scanned in a two-dimensional direction, and

a scanning optical system having a non-rotationally symmetric surface, wherein:

said scanning optical system comprises a decentered prism having at least one reflecting surface and configured into a shape in which a symmetric surface exists,

said scanning optical system is located such that said symmetric surface does substantially include the origin of a screen surface defined by a point of intersection of an optical axis of said scanning optical system with the surface to be scanned, and

said scanning optical system and said scanner unit are located such that one scanning direction is substantially in line with a direction of said symmetric surface.

Further, the present invention provides an image display system, comprising in combination:

a light source,

a scanner unit for scanning a light beam from said light source on the surface to be scanned in a two-dimensional direction,

a scanning optical system having a non-rotationally symmetric surface, and

an eyepiece optical system located in the vicinity of said surface to be scanned and having positive power, wherein:

said scanner unit has a gimbal structure, and

said scanning optical system comprises a decentered prism having an entrance surface through which a light beam scanned by said scanner unit enters said prism, at least one reflecting surface allowing a light beam entered from said entrance surface into said prism to be reflected in said prism and an exit surface through which a light beam reflected at said second reflecting surface leaves said prism, wherein at least one of said entrance surface, said reflecting surface and said exit surface comprises a non-rotationally symmetric surface.

Still other objects and advantages of the invention will in part be obvious and will in part be apparent from the specification.

The invention accordingly comprises the features of construction, combinations of elements, and arrangement of parts, which will be exemplified in the construction hereinafter set forth, and the scope of the invention will be indicated in the claims.

### BRIEF DESCRIPTION OF THE DRAWINGS

FIG. 1 is illustrative of the scanner unit having a gimbal structure and how two-dimensional scanning is performed by means of the scanner unit.

FIG. 2 is a representation of distortions upon scanning of the optical scanner using the scanner unit having the gimbal structure of FIG. 1.

FIG. 3 is illustrative in conception of the image display system according to the invention.

FIG. 4 is illustrative in conception of the image display system capable of viewing 3D images according to the invention.

FIG. 5 is illustrative in conception of the optical scanner in which light beams of three wavelengths are combined by an optical synthesis element into one single light beam.

FIGS. 6(a), 6(b) and 6(c) are illustrative of examples of how light sources of three colors are arranged.

FIG. 7 is illustrative of one exemplary arrangement of the image display system, in which R, G and B scanning lines are superposed with a time lag on one single scanning line for synthesis by electric signals, thereby displaying images in color.

FIG. 8 is illustrative of in what states the scanning lines in FIG. 7 are.

FIG. 9 is illustrative of the scanning direction of the two-dimensional scanning mirror where the decentered prism is located obliquely with respect to the center of the surface to be scanned.

FIG. 10 is illustrative in a Y-Z section of the whole arrangement of the optical system according to Inventive Example 1 from the surface to be scanned to the light source.

FIG. 11 is an optical path diagram in the Y-Z section for a substantial part of the optical system of Inventive Example 2.

FIG. 12 is illustrative in a Y-Z section of the whole arrangement of the optical system according to Inventive Example 2 from the surface to be scanned to the light source.

FIG. 13 is an optical path diagram in the Y-Z section for a substantial part of the optical system of Inventive Example 2.

FIG. 14 is an optical path diagram for the whole arrangement of the optical system according to Inventive Example 3 from the surface to be scanned to the light source, as projected onto a Y-Z plane.

FIG. 15 is an optical path diagram for a substantial part of the optical system of Inventive Example 3, as projected onto the Y-Z plane.

FIG. 16 is an optical path diagram for a substantial part of the optical system of Inventive Example 3, as projected onto an X-Y plane.

FIG. 17 is a representation similar to that of FIG. 2, indicative of distortions upon scanning in Example 1.

FIG. 18 is a representation similar to that of FIG. 2, indicative of distortions upon scanning in Example 2.

FIG. 19 is a representation similar to that of FIG. 2, indicative of distortions upon scanning in Example 3.

### DESCRIPTION OF THE PREFERRED EMBODIMENTS

The reasons for using the aforesaid arrangements in the invention and how they work will now be explained in detail.

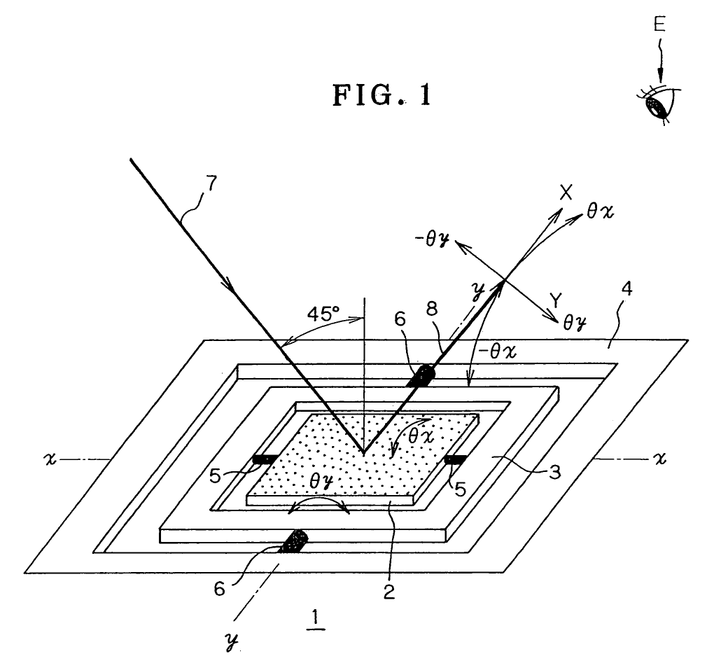

FIG. 1 is illustrative of the scanner unit having a gimbal structure and how to perform two-dimensional scanning with that scanner unit. The scanner unit 1 comprises a scanning mirror 2, a middle framework 3 and an outer framework 4. The scanning mirror 2 is coupled to the middle framework 3 by a shaft 5 that extends in an x-x axis direction. Then, the middle framework 3 is coupled to the outer framework 4 that is fixed by means of a shaft 6 extending in a y-y axis direction orthogonal to the x-x axis. Thus, light reflected at the scanning mirror 2 is horizontally scanned (X-direction scanning) by fluctuating motion of the scanning mirror 2 around the shaft 5, and vertically scanned (Y-direction scanning) by fluctuating motion of the middle framework 3 and scanning mirror 2 around the shaft 6. The fluctuating motion around the shafts 5 and 6 may be induced in various driving fashions such as electromagnetic driving, electrostatic driving, and piezoelectric driving. That fluctuating motion could also be induced by virtue of elastic deformation of the shafts 5 and 6, or free rotation around the shaft 5 and 6.

In an optical scanner using such a scanner unit 1 having a gimbal structure, suppose now that an incident light beam 7 is obliquely incident on the reflecting surface of the scanning mirror 2. In this case, the positions in the X— and Y-directions of the incident light beam 7 on the surface to be scanned are not determined in proportion to the angle of rotation θx around the x-x axis and the angle of rotation θy around the y-y axis. Even with the angle of rotation θy fixed as shown typically in FIG. 1, there is a distortion (e.g., a circular arc distortion) of scanning lines, which may otherwise cause a change in the Y-direction position depending on the value of the angle of rotation θx. Such a distortion of scanning lines incurs a distortion of images on the surface to be scanned. That distortion is hereinafter referred to as the distortion upon scanning.

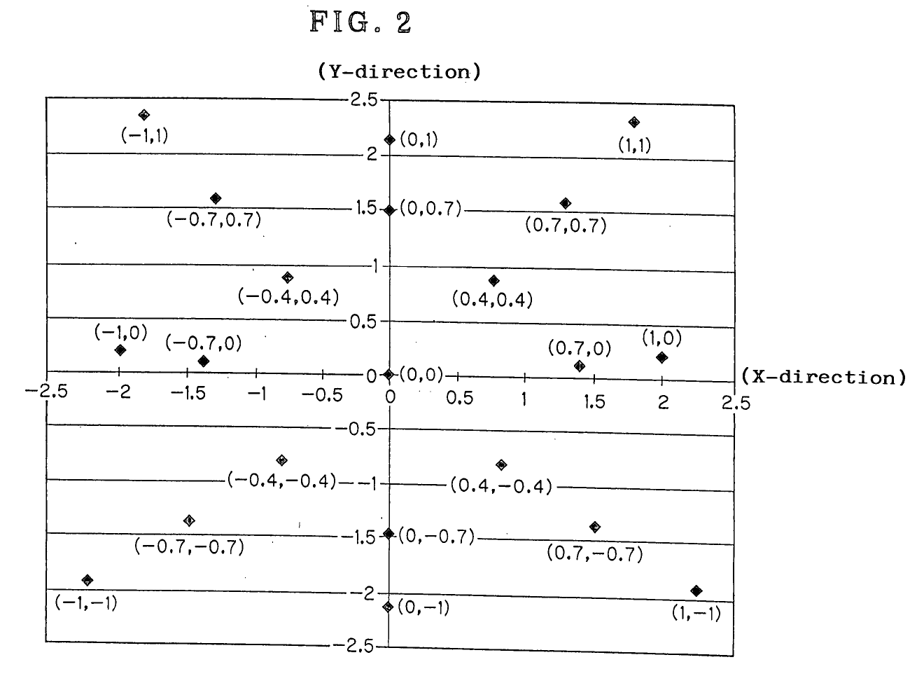

In FIG. 2, the positions of the beam on the surface to be scanned, which correspond to the values of (θx/θx max, θy/θy max) when the angle of incidence of the incident light beam 7 is 45°, are expressed in terms of (X, Y). Assume here that when the angle of rotation θx around the x-x axis is zero, the normal to the scanning mirror 2 lies in a plane including the incident light beam 7 and x-x axis. In the absence of any distortion upon scanning, a frame connecting together (1, 1)-(1, 0)-(1, −1)-(0, −1)-(−1, −1)(−1, 0)-(−1, 1)-(0, 1)-(1, 1) takes on a rectangle. With the optical scanner using the scanner unit 1 having a gimbal structure as shown in FIG. 1, however, there is such a distortion upon scanning as typically shown in FIG. 2.

To make correction for such a distortion upon scanning, the decentered prism is located in the scanning optical system in the invention. This decentered prism comprises an entrance surface through which a light beam scanned by the two-dimensional scanning mirror 1 enters the prism, a first reflecting surface for reflection in the prism of a light beam entered into the prism through the entrance surface, a second reflecting surface for reflection in the prism of a light beam reflected at the first reflecting surface and an exit surface through which a light beam reflected at the second reflecting surface leaves the prism. The respective surfaces are located such that the light beam from the entrance surface toward the first reflecting surface and the light beam from the second reflecting surface toward the exit surface cross each other in the prism. In the invention, at least one of the entrance surface, the first reflecting surface, the second reflecting surface and the exit surface is defined by a non-rotationally symmetric surface.

By use of such a decentered prism in which at least one of the entrance surface, the first reflecting surface, the second reflecting surface and the exit surface is constructed of a non-rotationally symmetric surface, the distortion upon scanning can effectively be corrected. More preferably, both the reflecting surfaces should be constructed of non-rotationally symmetric surfaces.

The optical path crosses over itself in the prism, and so the angle of incidence of light on the (first and second) reflecting surfaces becomes small with limited decentration aberrations. Unlike such a decentered prism as set forth in JP-A 2001-281583, it is unnecessary to satisfy total reflection conditions. This is also preferable because the inclination of light rays incident on the reflecting surfaces can be diminished.

Preferably but not exclusively, a free-form surface should be used for the non-rotationally symmetric surface shape. The free-form surface, for instance, is defined by formula (a) in U.S. Pat. No. 6,124,989 (JP-A 2000-66105), and the Z-axis of that defining formula provides the axis of the free-form surface.

For back ray tracing from the surface to be scanned to the scanning mirror (fluctuating mirror), it is important to satisfy both conditions (1) and (2) given below:

10°<Θ1<40° (1)

10°<Θ2<40° (2)

Here Θ1 and Θ2 are the angles that an axial chief ray (that is, a light ray leaving the center of the surface to be scanned and arriving at the center of the scanning mirror) subtends the normal to at least two internal reflecting surfaces as counted in order from the surface to be scanned at positions where it strikes those reflecting surface.

As the lower limit of 10° to these conditions is not reached, any large angle of scanning cannot be obtained because the reflecting surfaces block the effective diameter of the transmitting surfaces of the prism. It is also impossible to obtain any small-format system. As the upper limit of 40° is exceeded, the internal reflecting surfaces produce decentration aberrations too large to be corrected at other surfaces.

More preferably,

15°<Θ1<30° (1-1)

15°<Θ2<30° (2-1)

Referring specifically to Examples 1, 2 and 3 given later, the angles of incidence, Θ1 and Θ2, of the axial chief ray on at least two internal reflecting surfaces have the following values.

Example 1 Example 2 Example 3

Θ1 20.96 20.96 22.71

Θ2 21.92 21.92 22.00

More preferably, at least two internal reflecting surfaces should be located on the X-Z or Y-Z plane in the order of negative power and positive power as viewed from the side of the surface to be scanned. This is because the optical system has so the same construction as that of the retrofocus type that a large angle of scanning can be obtained at a small mirror angle of oscillation. Referring here to the definition of each axis in back ray tracing, the Z-axis is defined by the direction of the axial chief ray bent through the prism, and the X— and Y-axes are defined by two axes orthogonal to the Z-axis.

More preferably, the following condition (3) should be satisfied:

1°<Θm<45° (3)

Here Θm is the angle that the normal to a surface at a position where a light ray from a light source strikes that surface subtends a light ray incident on that position, as measured when a light ray at the center position of the screen surface is reflected at the scanning mirror. As the lower limit of 1° is not reached, the light beam incident on the scanning mirror cannot be separated from the light beam reflected at the scanning mirror. As the upper limit of 45° is exceeded, the distortion upon scanning becomes too large. It is difficult to correct that distortion upon scanning even by use of a decentered prism in which the optical path crosses over itself.

Most preferably,

3°<Θm<30° (3)

Referring here to Examples 1, 2 and 3 given later, the angle of incidence, Θm, of the axial chief ray on the scanning mirror has the following values.

Example 1 Example 2 Example 3

Θm 5.44 14.77 13.60

In the image display system of the invention using such a two-dimensional optical scanner as described above, an eyepiece optical system having positive power is located in the vicinity of the surface to be scanned, which is formed by the scanning optical system. This eyepiece optical system projects an exit pupil (usually in the form of a virtual image) in the vicinity of the pupil of a viewer.

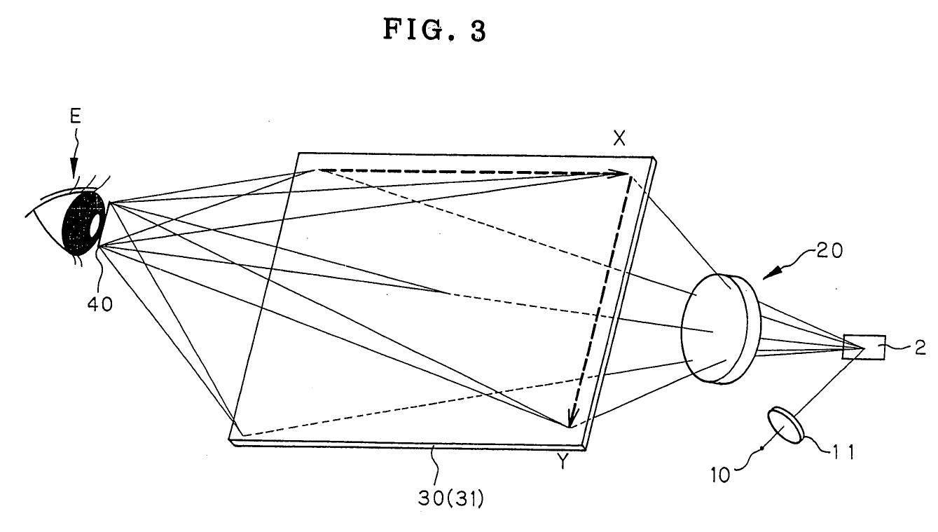

FIG. 3 is illustrative in conception of such an image display system. An eyepiece optical system 30 takes a role in projection of the exit pupil of a scanning optical system 20 onto the vicinity of the eyeball E of a viewer. By locating the eyepiece optical system 30 in the vicinity of the surface to be scanned by the scanning optical system 20, it is possible to condense a light beam leaving the scanning optical system 20 through the eyepiece optical system 30 for viewing purposes. It is thus possible to condense a substantial portion of the light beam given out of a light source 10 in the vicinity of the eyeball E of the viewer. The result is that the light from the light source 10 can effectively be used for viewing and, hence, bright images can be viewed in limited power consumption. In FIG. 3, reference numeral 11 is a illumination optical system for collimating the light from the light source 10 and entering it into a scanning mirror 2, and 40 is an image of the exit pupil of a two-dimensional optical scanner upon projected by the eyepiece optical system 30. The X-direction and Y-direction indicated at the position of the eyepiece optical system 30 stand for a main scanning direction and a sub-scanning direction, respectively.

While the scanning optical system 20 looks like a lens in FIG. 3, it is understood that it must actually be a decentered prism comprising an entrance surface, a first reflecting surface, a second reflecting surface and an exit surface.

By locating a diffusing surface 31 having optical diffusibility in the vicinity of the surface to be scanned, it is possible to make wide the position where images can be viewed with the eyeball E of the viewer. The diffusing surface having perfect scatter capability is preferred because of being free from illuminance fluctuations with the viewing position and constraints on the viewing direction. When power saving and size reductions are put first, however, it is preferable to use a diffusing plate having a narrow angle of diffusion because of significant improvements in the efficient of utilization of light from the light source 10. More preferably, the angle of diffusion of light by the diffusing surface 31 should be within 20° at full width, at which light intensity goes down to 1/10.

At least two reflecting surfaces 31 should be provided. By locating at least two reflecting surfaces 31 in a superposed fashion along the optical axis, scintillation can be reduced even with diffusing surfaces having similar surface roughness.

The eyepiece optical system 30 used herein may be a common positive lens, a Fresnel lens of positive power, a reflecting mirror or a Fresnel reflecting mirror. The lens surfaces or reflecting surfaces of these components may be each composed of not only a rotationally symmetric surface but a decentered Fresnel lens surface, a Fresnel reflecting surface, a free-form surface or an anamorphic surface as well. These reflecting mirrors may be either of the front surface type or of the back-surface type; however, the Fresnel reflecting mirror should preferably be in the form of a back-surface mirror, a substantial back-surface mirror portion of which is defined by a Fresnel reflecting mirror.

The diffusing surface 31 having a diffusion action may also be integrally provided to at least one surface of such an eyepiece optical system 30. Alternatively, when the eyepiece optical system 30 is constructed using a Fresnel lens or a Fresnel reflecting mirror, diffusion action may be allocated to the Fresnel surface of each component.

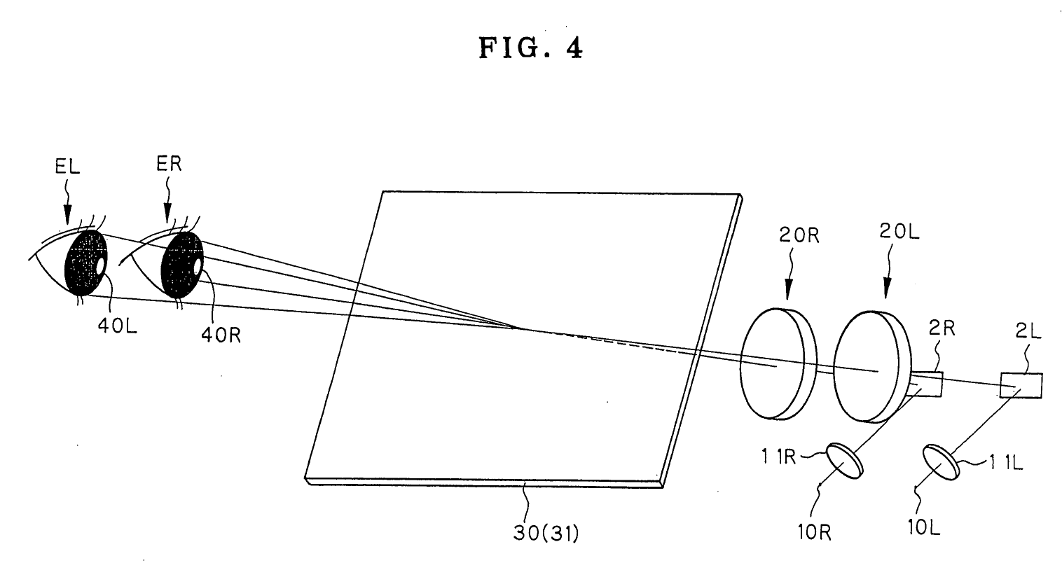

The image display system of the invention comprises a common eyepiece optical system 30, a left-eye two-dimensional scanner and a right-eye two-dimensional scanner. The eyepiece optical system 30 is located such that the exit pupil of a left-eye scanning optical system 20L is projected onto the vicinity of the pupil of the left eye EL of a viewer and the exit pupil of a right-eye scanning optical system 20R is projected onto the vicinity of the pupil of the right eye ER of the viewer, so that left and right images, for instance, images having binocular parallax are separately formed through optical scanners for the left and right eyes, whereby the viewer can see a 3D image. FIG. 4 is illustrative in conception of an image display system capable of viewing such 3D images. The image display system comprises a light source 10, an illumination optical system 11, a scanning mirror 2 and a scanning optical system 20. Reference numeral 40 stands for the exit pupil of the scanning optical system 20. Each reference numeral is suffixed with “L” and “R” indicative of the left eye and the right eye, respectively, and the left and right eyeballs are indicated at EL and ER, respectively.

For the image display system capable of viewing 3D images, too, the angle of diffusion by a diffusing surface 31 located in the vicinity of the surface to be scanned must be set at 20° or smaller as measured at full width where light intensity goes down to 1/10.

The scanning optical system used herein comprises a decentered prism. As already described, this decentered prism comprises an entrance surface that faces the scanning mirror, a first reflecting surface, a second reflecting surface and an exit surface that faces the surface to be scanned, at least one of which should preferably be allowed to serve also as the optical surface of the illumination optical system. This illumination optical system is provided to enter light from the light source into the scanning mirror. Thus, the decentered prism can have both actions, say, one for condensing a light beam from the light source on the scanning mirror and another for making correction for the distortion upon scanning.

Furthermore, at least one reflecting surface of the decentered prism should preferably be allowed to serve also as the optical surface of the illumination optical system.

For the light source used with the two-dimensional optical scanner and image display system of the invention, LEDs (light-emitting diodes) or LDs (laser diodes) are available. With these light-emitting devices, it is possible to reduce the size of the light source portion and, hence, the whole size of the system. The use of such light sources contributes to an enhancement of color reproducibility, especially of vibrant reds.

It is understood that by use of a light source including three colors, R (red), G (green) and B (blue), images can be reproduced in color.

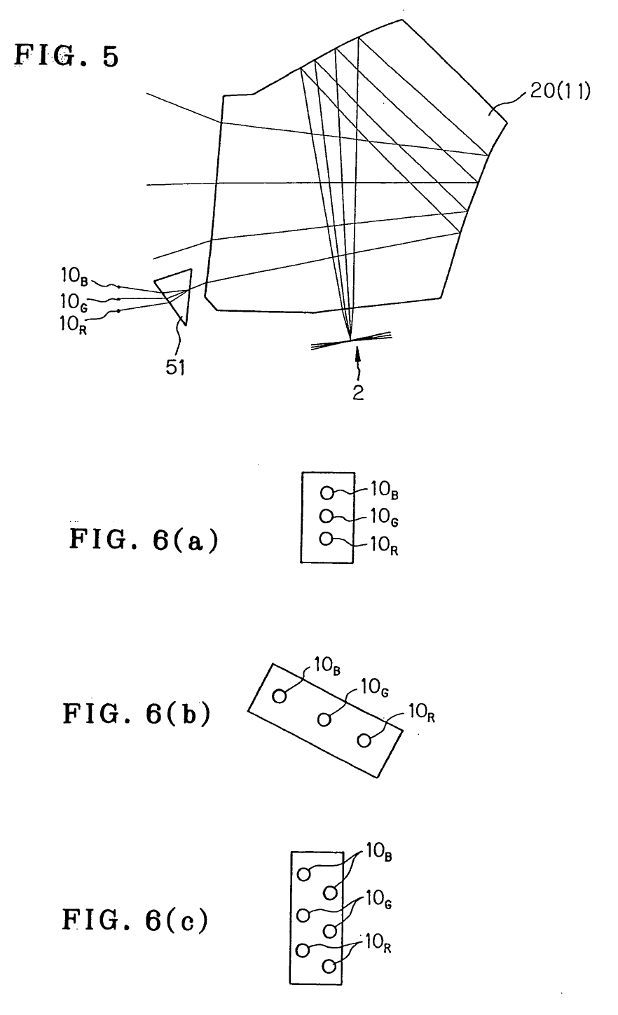

Furthermore, it is preferable to have an optical combination element for combining light from the light source, i.e., at least three colors or R, G and B. With this optical combination element, it is possible to combine light beams of at least three wavelengths into one single light beam and, hence, focus a scanning spot of each wavelength on one single point, as typically shown in a conceptual illustration of FIG. 5. In this example, light beams from light sources 10R, 10G and 10B of R, G and B three colors are combined through a chromatic dispersion prism 51 (acting as the optical combination element) into one single light beam. In FIG. 5, a scanning optical system 20 is shown as serving also as an illumination optical system 11. The light of three wavelengths upon incidence on the scanning optical system 20 is collimated there. Then, the collimated light of three wavelengths is incident on a scanning mirror 2, where it is deflected for two-dimensional scanning of the surface to be scanned.

For the optical combination element, not only the chromatic dispersion prism but also an optical combination element such as a DOE (diffractive optical element), an HOE (holography optical element) or a dichroic mirror may be used.

Preferably, the three-color light sources 10R, 10G and 10B should be located parallel in the sub-scanning direction, as shown in FIG. 6(a). In this case, the scan start position in the main scanning direction (X-direction) is the same for each color.

However, when the size of the light sources 10R, 10G and 10B is too large, they cannot often be located linearly in the sub-scanning direction (Y-direction) as shown in FIG. 6(a). In such a case, they may be located obliquely in the sub-scanning direction (Y-direction), as shown in FIG. 6(b). Upon scanning in the main scanning direction (X-direction), a difference is made among image signals (modulation signals) given to the respective light sources 10R, 10G and 10B. Specifically, the timing of application of image signals is delayed by a period of time corresponding to shifts of the respective light sources 10R, 10G and 10B in the main scanning direction (electronic chromatic aberration correction means).

Alternatively, as shown in FIG. 6(c), a plurality of (two in this case) light sources for each color R, G, and B may be provided to convert a light beam combined through the optical combination element into multiple beams. This may generate a plurality of (two in this case) scanning lines upon one scanning with the scanning mirror 2 for higher-definition image displays.

Furthermore, light sources of not only three colors R, G and B but also four or more colors may be used. If plural such light sources are displaced in parallel as shown in FIGS. 6(a) to 6(c), it is then possible to display images in color with good color reproducibility.

The present invention also provides an image display system comprising a light source, a scanner unit of gimbal structure for scanning a light beam from said light source in a two-dimensional direction, an illumination optical system for entering a light beam scanned by said scanner unit on the surface to be scanned and an eyepiece optical system having positive power and located in the vicinity of the surface to be scanned for projecting the exit pupil of said scanning optical system onto the vicinity of the pupil of a viewer, wherein:

said light source comprises light sources of at least three colors R, G and B, and

images of said light sources of at least three colors are mutually displaced, and

scanning is performed such that scanning lines drawn by said images of said light sources of at least three colors are substantially superposed one upon another with a time lag so that a light ray of each color is modulated by an image signal with a time lag corresponding to the first-mentioned time lag.

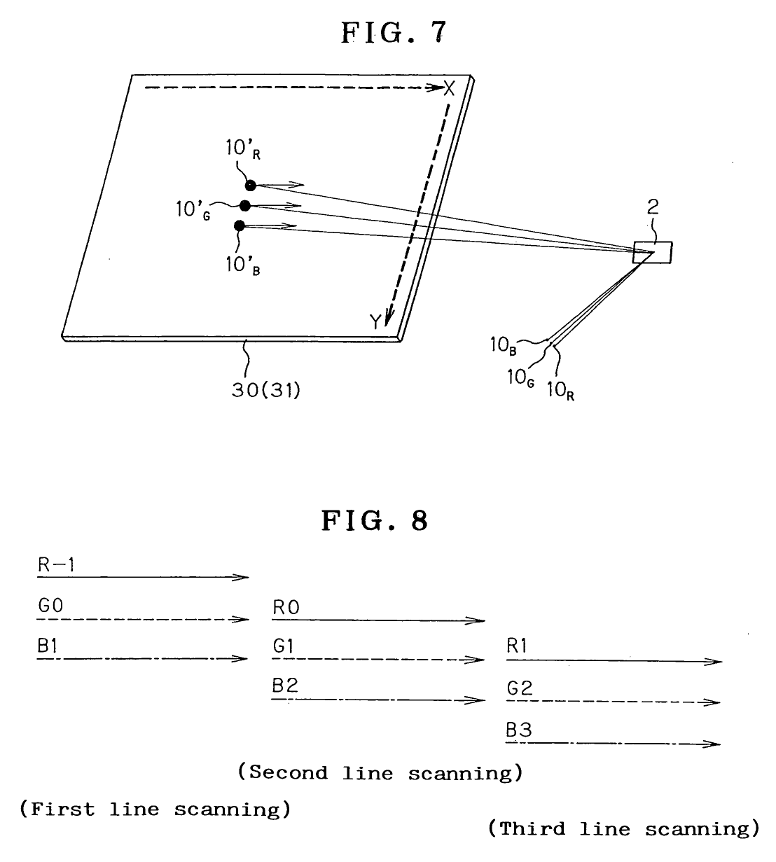

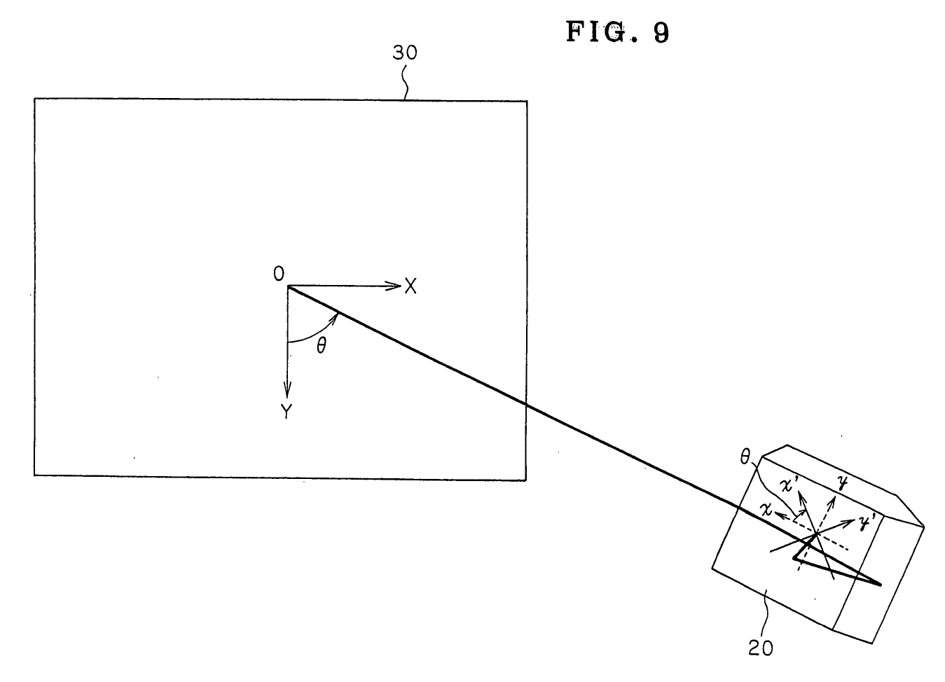

With such an optical combination element-free arrangement as recited above, while the R, G and G light sources are displaced, the surface to be scanned is scanned with parallel scanning lines by the R, G and B light sources, and R, G and B scanning lines are shifted with a given time lag and superposed on one single scanning line for combination by electric signals, so that images can be displayed in color. FIGS. 7 and 8 are illustrative in conception of how this is achieved. FIG. 7 is illustrative of one specific arrangement of the optical system, and FIG. 8 is illustrative of the scanning lines are arranged. In FIG. 7, the scanning optical system and illumination optical system are not shown.

In this arrangement, light sources 10R, 10G and 10B of three colors are arranged parallel in the sub-scanning direction. Thus, images 10R′, 10G′ and 10B′ of the light sources 10R, 10G and 10B are projected parallel onto the surface to be scanned (the surface of the eyepiece optical system 30 ) in the sub-scanning line (Y-direction). Upon main scanning by the scanning mirror 2 in this state, the scanning spots 10R′, 10G′ and 10B′ of R, G and B move simultaneously, drawing scanning lines for R, G and B.

As shown in FIG. 8, upon the first scanning operation, the three scanning lines for R, G and B are drawn while they are mutually shifted by one scanning line. At this time, R is modulated by a signal for the −first scanning line; G is modulated by a signal for the zero scanning line; and B is modulated by a signal for the first scanning line. However, there is no image signal at the −first scanning line and the zero scanning line, and so the light sources 10R and 10G for R and G are not put on. In other words, the first scanning is performed only by the light source 10B for B.

The second scanning is performed while the three scanning lines are shifted by one scanning line in the Y-direction. At this time, R is modulated by a signal for the zero scanning line; G is modulated by a signal for the first scanning line; and B is modulated by a signal for the second scanning line. However, there is no image signal on the zero scanning line, and so the light source for R at the second scanning is not put on. In other words, the second scanning is performed only by the light sources 10G and 10B for G and B.

The third scanning is performed while the three scanning lines are shifted by an additional one scanning line in the Y-direction. At this time, R is modulated by a signal for the first scanning line; G is modulated by a signal for the second scanning line; and G is modulated by a signal for the third scanning line. In this case, each light source is held on.

Thus, if scanning is performed three times while the three R, G and B scanning lines are shifted by one scanning line in the Y-direction for each scanning, R, G and B are put one upon another at the first scanning line so that images can be displayed in color. The same holds true for the second and subsequent line scanning. In this way, even when the light sources 10R, 10G and 10B are shifted, the scanning screen can be viewed without any chromatic aberration. It is noted that the amount of shifts of the images 10R′, 10G′ and 10B′ of the light sources 10R, 10G and 10B should preferably be equal to or an integral multiple of the scanning line spacing on the surface to be scanned.

By use of light sources of four or more colors, color reproducibility can be much more improved.

Furthermore, the present invention provides a two-dimensional optical scanner comprising a light source, a scanner unit for scanning a light beam from said light source in a two-dimensional direction, and a scanning optical system including a non-rotationally symmetric surface having an action on correction of distortion upon scanning of a light beam scanned by said scanner unit, wherein:

said scanning optical system comprises a decentered prism having at least one reflecting surface as well as a symmetric surface,

said scanning optical system is located such that when the origin of a screen is defined by the point of intersection of the optical axis of said scanning optical system with the surface to be scanned, said symmetric surface substantially includes said origin of the screen, and

said scanning optical system and said scanner unit are located such that one scanning direction is substantially in line with the direction of said symmetric surface.

If the symmetric surface of the scanning optical system is designed to include the origin of the screen (the center of an image), it is then possible to bring the direction of generation of non-rotationally symmetric distortion upon scanning in line with the direction of the symmetric surface, thereby making correction for an image distortion by decentration aberration and facilitating correction of aberrations.

Suppose now that the scanning optical system is rotated at an angle θ around the normal to the origin O of the surface to be scanned. Referring to FIG. 9 as an example, a decentered prism 20 is rotated at an angle θ counterclockwise from a state where its symmetric surface is in line with the Y-direction. In this case, the symmetric surface of the decentered prism 20, too, is rotated at an angle θ counterclockwise with respect to the Y-direction. Correspondingly, the scanner unit is rotated at just an angle θ with respect to the decentered prism 20 with the axis of rotation defined by the optical axis of the decentered prism 20. The then direction of rotation is clockwise as viewed from the side of the decentered prism 20. In other words, a scanning light beam incident on the decentered prism 20 is turned from an x-x direction to an x′-x′ direction, so that scanning can be performed in the same X- and Y-directions as those before the rotation of the decentered prism 20. In such a rotation arrangement, two two-dimensional optical scanners may be provided for one eyepiece optical system 30 such that they are located on both sides of a vertical plane inclusive of the normal to the origin O of the surface to be scanned.

For instance, two scanning optical systems 20 having the same configuration may be provided to set up an image display system capable of viewing 3D images such as one shown in FIG. 4. This makes it possible to cut down the fabrication cost of scanning optical systems 20 more significantly as compared with when they are configured into different shapes, for instance, mutually plane-symmetric shapes. In this case, it is understood that the respective light sources for both two-dimensional optical scanners could be modulated by image signals so as to present separate image displays or, alternatively, they could be modulated by the same image signals so as to present the same image displays.

The optical system used with the two-dimensional optical scanner and image display system of the invention is now explained with reference to Examples 1, 2 and 3.

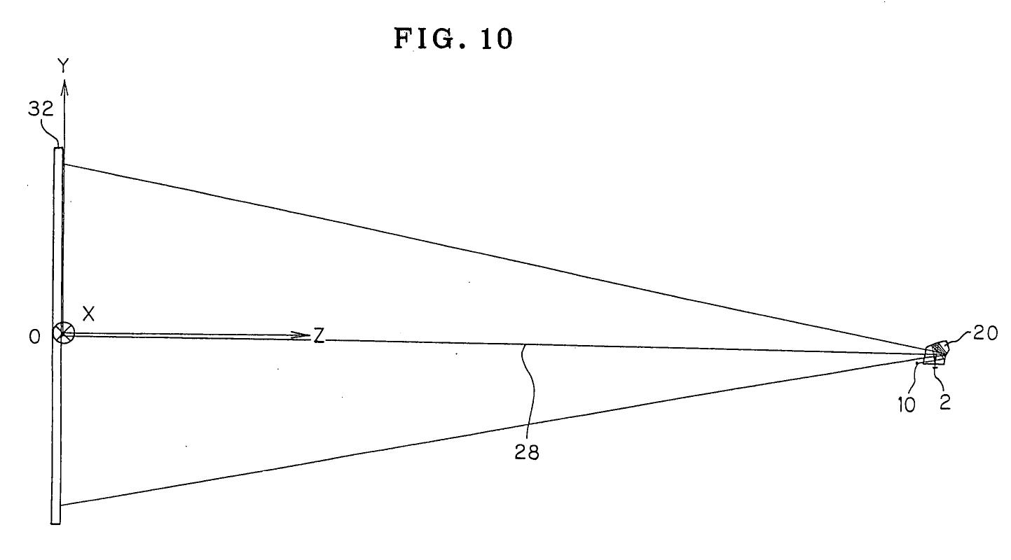

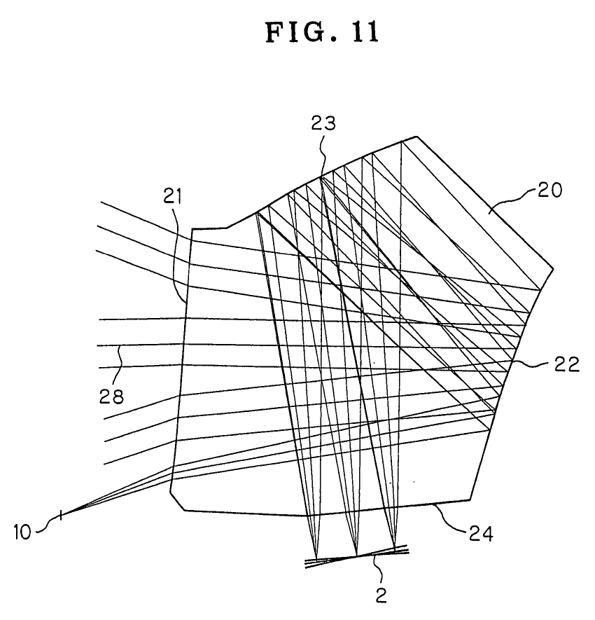

Constituting parameters of Examples 1, 2 and 3 will be given later. In the examples, ray tracing is carried out in the form of so-called back ray tracing in order from the surface 32 to be scanned via the decentered prism 20 that forms the scanning optical system, the scanning mirror 2 and the combined surface of the decentered prism 20 forming the illumination optical system toward the light source 10. As shown in FIG. 10, an axial chief ray 28 is defined by a light ray that passes through the center O of the surface 32 to be scanned and the center of a scanning mirror 2 that forms the pupil of an optical system and arrives at a light source 10. In the back ray tracing, a Z-axis is defined by a direction along the axial chief ray 28 with the origin of the decentered optical surface of a scanning optical system (decentered prism) given by the center O of the surface 32 to be scanned. The positive direction of the Z-axis is defined by a direction from the surface 32 to be scanned toward the surface of the decentered prism 20, which faces that surface 32. A Y-Z plane is defined by a plane parallel to the paper, and the positive direction of an X-axis is defined by a direction that passes through the origin and intersects at right angles with the Y-Z plane, running through the paper from its front surface. A Y-axis is defined by an axis that forms a right-hand orthogonal coordinate system with the X- and Z-axes.

For the decentered surface, there are given the amount of decentration of its apex from the center O of the origin of the optical system and the angles of inclination of its center axis around the X—, Y— and Z-axes (α, β, γ(°)). Here the amounts of decentration in the X—, Y— and Z-axis directions are referred to as X, Y and Z. The center axis is defined by the Z-axis of the aforesaid formula (a) for the free-form surface. In that case, the positive for α and β means counterclockwise rotation with respect to the positive direction of the respective axes, and the positive for γ means clockwise rotation with respect to the positive direction of the Z-axis. For α, β and γ rotation of the center axis of the surface, the center axis of the surface and its XYZ orthogonal coordinate system are first counterclockwise rotated around the X-axis by α. Then, the center axis of the rotated surface is counterclockwise rotated around the Y-axis of a new coordinate system by β while the once rotated coordinate system is counterclockwise rotated around the Y-axis by β. Then, the center axis of the twice rotated surface is clockwise rotated around the Z-axis of a new coordinate system by γ.

The surface shape of the free-form surface used herein, for instance, is defined by formula (a) in U.S. Pat. No. 6,124,989 (JP-A 2000-66105).

It is noted that the term concerning the free-form surface on which no data are given is zero. Refractive index is given on a d-line (587.56 nm) basis and length is given in mm.

In Examples 1, 2 and 3, the size of the surface 32 to be scanned is 162.56×121.92 mm with a numerical aperture NA of 0.002. The angles of rotation, θx and θy, of the scanning mirror 2 are tabulated below.

Ex. 1 Ex. 2 Ex. 3

θx ±7.67 ±9.63 ±9.57

θy ±3.22 ±7.02 ±4.19

The arrangements of the optical system in the examples are now explained.

### EXAMPLE 1

The optical system of Example 1 is shown in FIGS. 10 and 11. FIG. 10 is an optical path diagram in a Y-Z section for the whole optical system from the surface 32 to be scanned to a light source 10, and FIG. 11 is an optical path diagram in the Y-Z section for a substantial part thereof. In this example, the scanning optical system is made up of a decentered prism located in opposition to the surface 32 to be scanned. As viewed in order of back ray tracing, the decentered prism, shown at 20, has a first surface 21 providing an exit surface, a second surface 22 providing a second reflecting surface, a third surface 23 providing a first reflecting surface and a fourth surface 24 providing an entrance surface. There is then a two-dimensional scanning mirror 1 (FIG. 1), i.e., a scanning mirror 2 that faces the fourth surface 24 of the decentered prism 20. A light source 10 is located at a decentration position spaced away from an axial chief ray 28 for the first surface 21. A light beam from the light source 10 enters the decentered prism 20 from its first surface 21, and is then internally reflected at the second surface 22 and the third surface 23 in this order, entering the scanning mirror 2 via the fourth surface 24. After reflected and scanned at the scanning mirror 2 that rotates with two orthogonal axes of rotation, the light beam enters the decentered prism 20 via the fourth surface 24. Then, the light beam is internally reflected at the third surface 23 and the second surface 24 of the decentered prism in this order, leaving the prism via the first surface 21. Leaving the decentered prism 20, the light forms scanning lines on the surface 32 to be scanned, which is located at a distance.

In the decentered prism 20 according to the instant example, the respective surfaces are located such that the light beam from the fourth surface 24 toward the third surface 23 crosses the light beam from the second surface 22 toward the first surface 21. The first surface 21 is made up of a spherical (concave) surface while the second surface 22, third surface 23 and fourth surface 24 are each made up of a free-form surface. The first surface 21 to the fourth surface 24 are each decentered in the Y-Z plane. The first surface 21 to the fourth surface 24 of the decentered prism 20 are all allowed to serve also as the optical surfaces of the scanning optical system and the illumination optical system.

### EXAMPLE 2

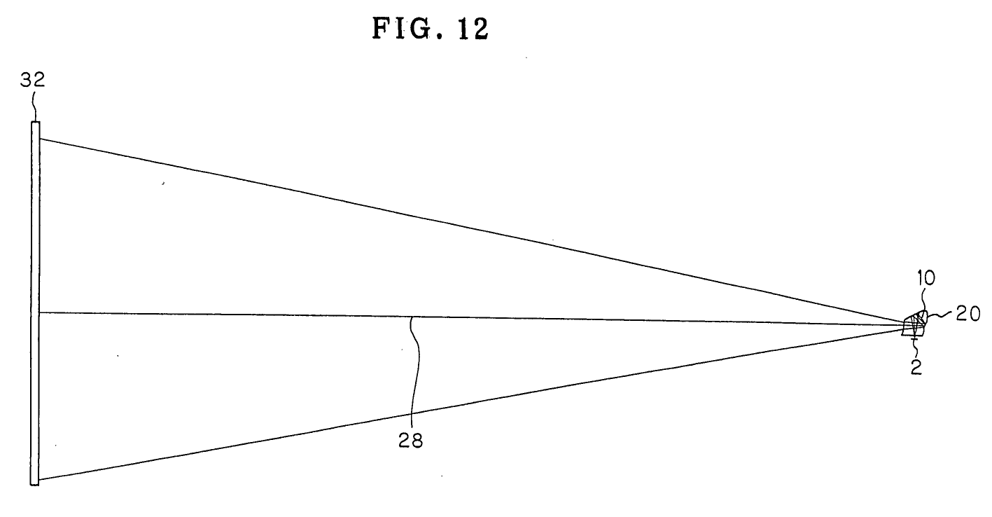

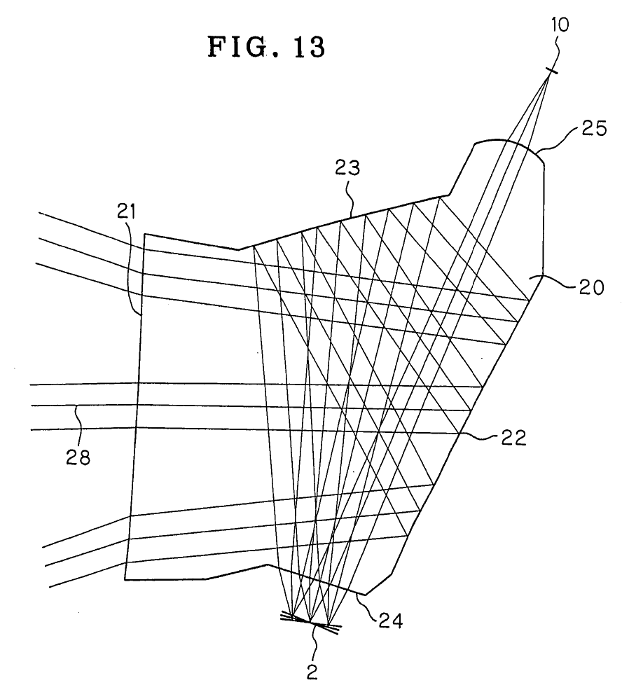

The optical system of Example 2 is shown in FIGS. 12 and 13. FIG. 12 is an optical path diagram in a Y-Z section for the whole optical system from the surface 32 to be scanned to a light source 10, and FIG. 13 is an optical path diagram in the Y-Z section for a substantial part thereof. In this example, the scanning optical system is made up of a decentered prism located in opposition to the surface 32 to be scanned. As viewed in order of back ray tracing, the decentered prism, shown at 20, has a first surface 21 providing an exit surface, a second surface 22 providing a second reflecting surface, a third surface 23 providing a first reflecting surface, a fourth surface 24 providing an entrance surface and a fifth surface 25 providing the entrance surface of an illumination optical system. There is then a two-dimensional scanning mirror 1 (FIG. 1), i.e., a scanning mirror 2 that faces the fourth surface 24 of the decentered prism 20, and there is a light source 10 that faces the fifth surface 25. A light beam from the light source 10 enters the decentered prism 20 from its fifth surface 25, and leaves the prism through the fourth surface 24, entering the scanning mirror 2. After reflected and scanned at the scanning mirror 2 that rotates with two orthogonal axes of rotation, the light beam enters the decentered prism 20 via the fourth surface 24. Then, the light beam is internally reflected at the third surface 23 and the second surface 24 of the decentered prism 20 in this order, leaving the prism via the first surface 21. Leaving the decentered prism 20, the light forms scanning lines on the surface 32 to be scanned, which is located at a distance.

In the decentered prism 20 according to the instant example, the respective surfaces are located such that the light beam from the fourth surface 24 toward the third surface 23 crosses the light beam from the second surface 22 toward the first surface 21. The fifth surface 25 is interposed between the second surface 22 and the third surface 23. The first surface 21 is made up of a spherical (concave) surface and the fifth surface 25 is made up of a spherical (convex) surface while the second surface 22, third surface 23 and fourth surface 24 are each made up of a free-form surface. The first surface 21 to the fifth surface 25 are each decentered in the Y-Z plane. Only the fourth surface 24 of the decentered prism 20 is allowed to serve also as the optical surfaces of the scanning optical system and the illumination optical system.

### EXAMPLE 3

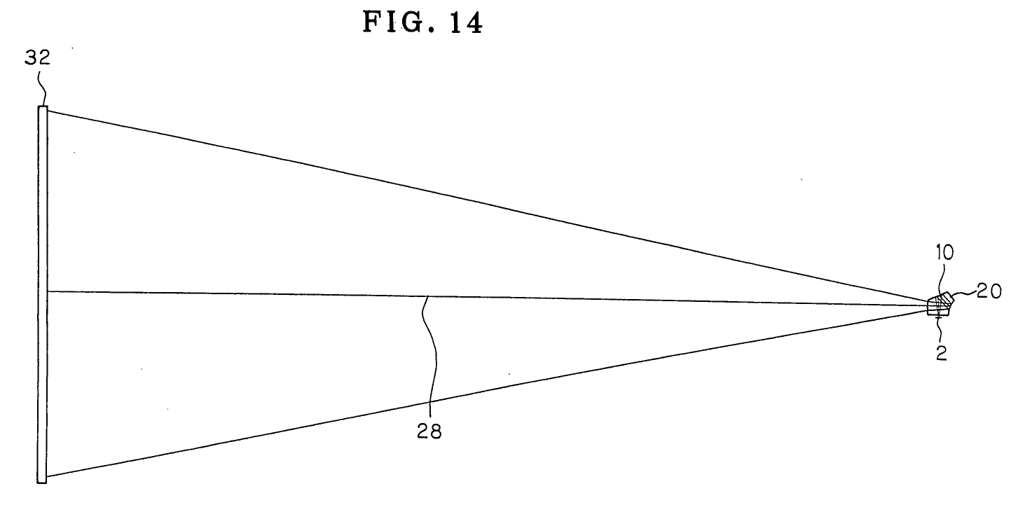

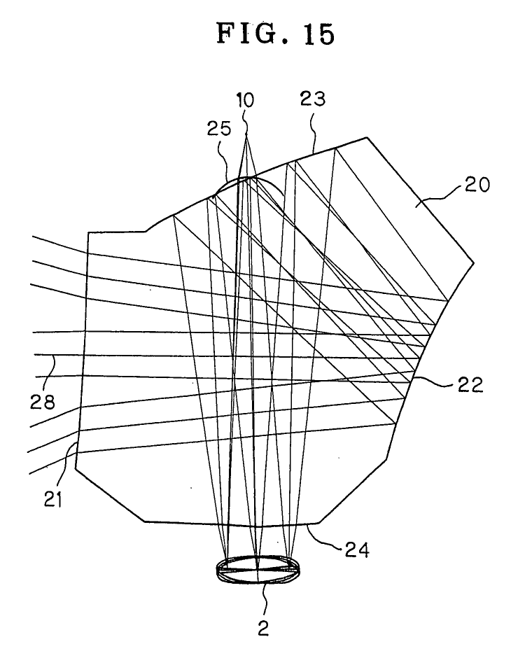

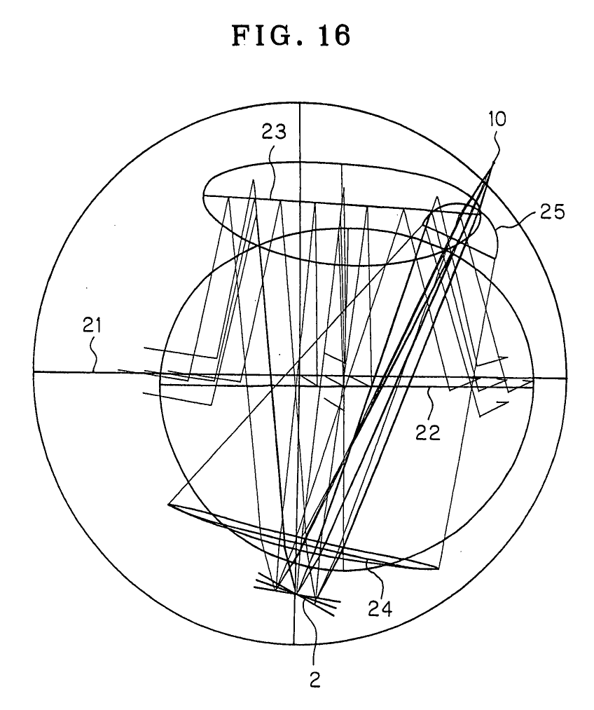

The optical system of Example 3 is shown in FIGS. 14 and 15. FIG. 14 is an optical path diagram for the whole optical system from the surface 32 to be scanned to a light source 10 as projected onto a Y-Z plane, and FIG. 15 is an optical path diagram for a substantial part thereof as projected onto the Y-Z plane. FIG. 16 is an optical path diagram for that substantial part as proposed onto an X-Y plane. In this example, the scanning optical system is made up of a decentered prism located in opposition to the surface 32 to be scanned. As viewed in order of back ray tracing, the decentered prism, shown at 20, has a first surface 21 providing an exit surface, a second surface 22 providing a second reflecting surface, a third surface 23 providing a first reflecting surface, a fourth surface 24 providing an entrance surface and a fifth surface 25 providing the entrance surface of an illumination optical system. There is then a two-dimensional scanning mirror 1 (FIG. 1), i.e., a scanning mirror 2 that faces the fourth surface 24 of the decentered prism 20, and there is a light source 10 that faces the fifth surface 25. A light beam from the light source 10 enters the decentered prism 20 from its fifth surface 25, and leaves the prism through the fourth surface 24, entering the scanning mirror 2. After reflected and scanned at the scanning mirror 2 that rotates with two orthogonal axes of rotation, the light beam enters the decentered prism 20 via the fourth surface 24. Then, the light beam is internally reflected at the third surface 23 and the second surface 24 of the decentered prism 20 in this order, leaving the prism via the first surface 21. Leaving the decentered prism 20, the light forms scanning lines on the surface 32 to be scanned, which is located at a distance.

In the decentered prism 20 according to the instant example, the respective surfaces are located such that the light beam from the fourth surface 24 toward the third surface 23 crosses the light beam from the second surface 22 toward the first surface 21, as projected onto the same plane. The fifth surface 25 is interposed between the second surface 22 and the third surface 23. The first surface 21 is made up of a spherical (concave) surface and the fifth surface 25 is made up of a spherical (convex) surface while the second surface 22, third surface 23 and fourth surface 24 are each made up of a free-form surface. The first surface 21 to the fifth surface 25 are each decentered in the Y-Z plane. The first surface 21 to fifth surface 25 having no symmetric plane are all three-dimensionally decentered. Only the fourth surface 24 of the decentered prism 20 is allowed to serve also as the optical surfaces of the scanning optical system and the illumination optical system.

Numerical data on each example are enumerated just below. It is noted that “FFS” and “RE” stand for a free-form surface and a reflecting surface, respectively. It is also noted that the “stop surface” and “image plane” correspond to the locations of scanning mirror 2 and the light source 10, respectively.

### EXAMPLE 1

| Surface | Radius of | Surface | Displacement | Refractive | Abbe's |
|---|---|---|---|---|---|
| No. | curvature | separation | and tilt | index | No. |
| Object | ∞ | | | | |
| plane | | | | | |
| 1 | −79.97 | | (1) | 1.5163 | 64.1 |
| 2 | FFS\mathring{1} (RE) | | (2) | 1.5163 | 64.1 |
| 3 | FFS\mathring{2} (RE) | | (3) | 1.5163 | 64.1 |
| 4 | FFS\mathring{3} | | (4) | | |
| 5 | ∞ (Stop, RE) | | (5) | | |
| 6 | FFS\mathring{3} | | (4) | 1.5163 | 64.1 |
| 7 | FFS\mathring{2} (RE) | | (3) | 1.5163 | 64.1 |
| 8 | FFS\mathring{1} (RE) | | (2) | 1.5163 | 64.1 |
| 9 | −79.97 | | (1) | | |
| Image | ∞ | | (6) | | |
| plane | | | | | |

FFS1

| | | |
|---|---|---|
| C₄ −6.6088 × 10⁻⁴ | C₆ 2.8522 × 10⁻² | C₈ −1.7642 × 10⁻⁴ |
| C₁₀ 1.3236 × 10⁻³ | | |

FFS2

| | | |
|---|---|---|
| C₄ 2.6020 × 10⁻³ | C₆ 1.7350 × 10⁻² | C₈ −2.7790 × 10⁻⁴ |
| C₁₀ 5.7847 × 10⁻⁴ | | |

FFS3

| | | |
|---|---|---|
| C₄ −1.6675 × 10⁻² | C₆ −1.1273 × 10⁻² | C₈ −7.8530 × 10⁻⁴ |
| C₁₀ 2.0480 × 10⁻⁴ | | |

Displacement and tilt(1)

| | | | | | |
|---|---|---|---|---|---|
| X | 0.00 | Y | 0.00 | Z | 300.00 |
| α | −5.13 | β | 0.00 | γ | 0.00 |

Displacement and tilt(2)

| | | | | | |
|---|---|---|---|---|---|
| X | 0.00 | Y | 0.00 | Z | 308.00 |
| α | −23.55 | β | 0.00 | γ | 0.00 |

Displacement and tilt(3)

| | | | | | |
|---|---|---|---|---|---|
| X | 0.00 | Y | 4.00 | Z | 304.00 |
| α | −66.38 | β | 0.00 | γ | 0.00 |

Displacement and tilt(4)

| | | | | | |
|---|---|---|---|---|---|
| X | 0.00 | Y | −4.00 | Z | 304.00 |
| α | −86.11 | β | 0.00 | γ | 0.00 |

Displacement and tilt(5)

| | | | | | |
|---|---|---|---|---|---|
| X | 0.00 | Y | −5.00 | Z | 304.00 |
| α | −82.77 | β | 0.00 | γ | 0.00 |

Displacement and tilt(6)

| | | | | | |
|---|---|---|---|---|---|
| X | 0.00 | Y | −4.00 | Z | 297.00 |
| α | 0.00 | β | 0.00 | γ | 0.00 |

### EXAMPLE 2

| Surface | Radius of | Surface | Displacement | Refractive | Abbe's |
|---|---|---|---|---|---|
| No. | curvature | separation | and tilt | index | No. |
| Object | ∞ | | | | |
| plane | | | | | |
| 1 | −94.74 | | (1) | 1.5163 | 64.1 |
| 2 | FFS\mathring{1} | | (2) | 1.5163 | 64.1 |
| 3 | FFS\mathring{2} (RE) | | (3) | 1.5163 | 64.1 |
| 4 | FFS\mathring{3} (RE) | | (4) | | |
| 5 | ∞ (Stop, RE) | | (5) | | |
| 6 | FFS\mathring{3} | | (4) | 1.5163 | 64.1 |
| 7 | 1.26 | | (6) | | |
| Image | ∞ | | (7) | | |
| plane | | | | | |

FFS1

| | | |
|---|---|---|
| C₄ −5.5688 × 10⁻³ | C₆ −2.9091 × 10⁻⁴ | C₈ −1.5556 × 10⁻⁴ |
| C₁₀ −6.9408 × 10⁻⁵ | | |

FFS2

| | | |
|---|---|---|
| C₄ −2.0513 × 10⁻⁴ | C₆ 6.7662 × 10⁻³ | C₈ 5.7772 × 10⁻⁶ |
| C₁₀ −1.7393 × 10⁻⁴ | | |

FFS3

| | | |
|---|---|---|
| C₄ −1.0549 × 10⁻² | C₆ −4.1489 × 10⁻⁴ | C₈ −2.7158 × 10⁻³ |
| C₁₀ −4.1204 × 10⁻³ | | |

Displacement and tilt(1)

| | | | | | |
|---|---|---|---|---|---|
| X | 0.00 | Y | 0.00 | Z | 300.00 |
| α | −4.41 | β | 0.00 | γ | 0.00 |

Displacement and tilt(2)

| | | | | | |
|---|---|---|---|---|---|
| X | 0.00 | Y | 0.00 | Z | 308.00 |
| α | −28.91 | β | 0.00 | γ | 0.00 |

Displacement and tilt(3)

| | | | | | |
|---|---|---|---|---|---|
| X | 0.00 | Y | 4.00 | Z | 304.00 |
| α | −75.62 | β | 0.00 | γ | 0.00 |

Displacement and tilt(4)

| | | | | | |
|---|---|---|---|---|---|
| X | 0.00 | Y | −4.00 | Z | 304.00 |
| α | −106.76 | β | 0.00 | γ | 0.00 |

Displacement and tilt(5)

| | | | | | |
|---|---|---|---|---|---|
| X | 0.00 | Y | −5.00 | Z | 304.00 |
| α | −105.00 | β | 0.00 | γ | 0.00 |

Displacement and tilt(6)

| | | | | | |
|---|---|---|---|---|---|
| X | 0.00 | Y | 6.00 | Z | 309.00 |
| α | −106.35 | β | 0.00 | γ | 0.00 |

Displacement and tilt(7)

| | | | | | |
|---|---|---|---|---|---|
| X | 0.00 | Y | 7.73 | Z | 310.00 |
| α | −120.00 | β | 0.00 | γ | 0.00 |

### EXAMPLE 3

| Surface | Radius of | Surface | Displacement | Refractive | Abbe's |
|---|---|---|---|---|---|
| No. | curvature | separation | and tilt | index | No. |
| Object | ∞ | | | | |
| plane | | | | | |
| 1 | −62.94 | | (1) | 1.5163 | 64.1 |
| 2 | FFS\mathring{1} | | (2) | 1.5163 | 64.1 |
| 3 | FFS\mathring{2} (RE) | | (3) | 1.5163 | 64.1 |
| 4 | FFS\mathring{3} (RE) | | (4) | | |
| 5 | ∞ (Stop, RE) | | (5) | | |
| 6 | FFS\mathring{3} | | (4) | 1.5163 | 64.1 |
| 7 | 0.94 | | (6) | | |
| Image | ∞ | | (7) | | |
| plane | | | | | |

FFS1

| | | |
|---|---|---|
| C₄ −3.7791 × 10⁻³ | C₅ 2.7291 × 10⁻³ | C₆ 3.5045 × 10⁻² |
| C₇ −1.1556 × 10⁻⁴ | C₈ 5.0706 × 10⁻⁵ | C₉ −1.5321 × 10⁻⁴ |
| C₁₀ 2.4130 × 10⁻³ | C₁₁ 2.0499 × 10⁻⁵ | |

FFS2

| | | |
|---|---|---|
| C₄ 4.3737 × 10⁻³ | C₅ 1.4250 × 10⁻³ | C₆ 2.6368 × 10⁻² |
| C₇ −4.4253 × 10⁻⁵ | C₈ 3.6516 × 10⁻⁵ | C₉ 1.2045 × 10⁻⁴ |
| C₁₀ 7.8390 × 10⁻⁴ | C₁₁ −1.0967 × 10⁻⁶ | |

FFS3

| | | |
|---|---|---|
| C₄ −2.9872 × 10⁻² | C₆ −1.8337 × 10⁻² | C₈ 1.8238 × 10⁻³ |
| C₁₀ −3.3349 × 10⁻⁴ | | |

Displacement and tilt(1)

| | | | | | |
|---|---|---|---|---|---|
| X | 0.00 | Y | 0.00 | Z | 300.00 |
| α | −4.88 | β | −8.96 | γ | 0.00 |

Displacement and tilt(2)

| | | | | | |
|---|---|---|---|---|---|
| X | 1.07 | Y | −0.23 | Z | 308.00 |
| α | −24.37 | β | −2.44 | γ | 0.00 |

Displacement and tilt(3)

| | | | | | |
|---|---|---|---|---|---|
| X | 0.96 | Y | 4.00 | Z | 304.07 |
| α | −68.70 | β | 2.80 | γ | 0.00 |

Displacement and tilt(4)

| | | | | | |
|---|---|---|---|---|---|
| X | 0.07 | Y | −4.00 | Z | 304.00 |
| α | −91.37 | β | 11.33 | γ | 0.00 |

Displacement and tilt(5)

| | | | | | |
|---|---|---|---|---|---|
| X | 0.00 | Y | −5.00 | Z | 304.00 |
| α | −89.66 | β | 17.38 | γ | 0.00 |

Displacement and tilt(6)

| | | | | | |
|---|---|---|---|---|---|
| X | 4.06 | Y | 4.00 | Z | 304.00 |
| α | −90.11 | β | 23.39 | γ | 0.00 |

Displacement and tilt(7)

| | | | | | |
|---|---|---|---|---|---|
| X | 4.50 | Y | 5.00 | Z | 304.00 |
| α | −90.00 | β | 21.08 | γ | 0.00 |

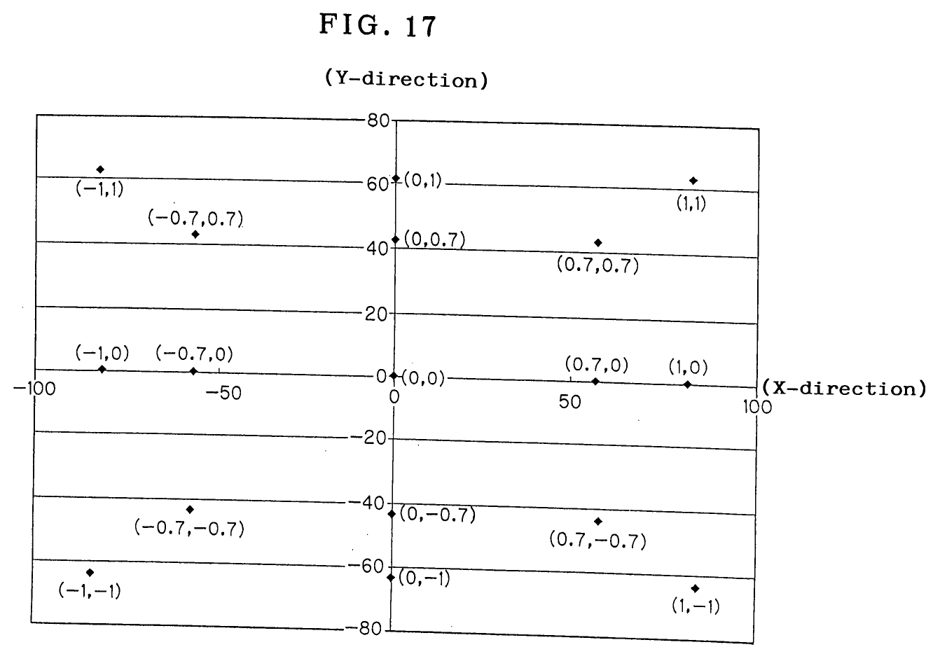

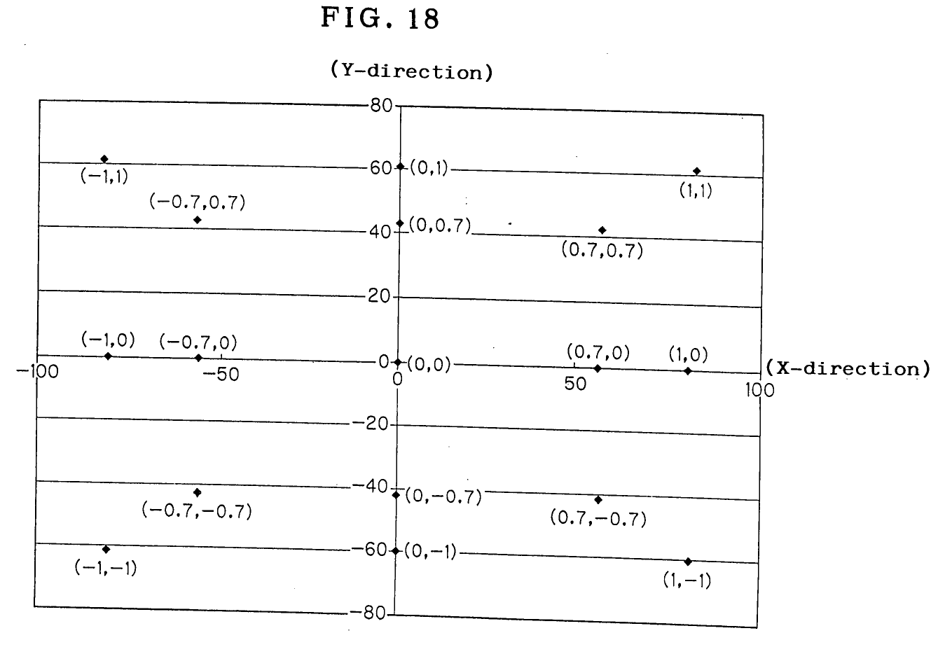

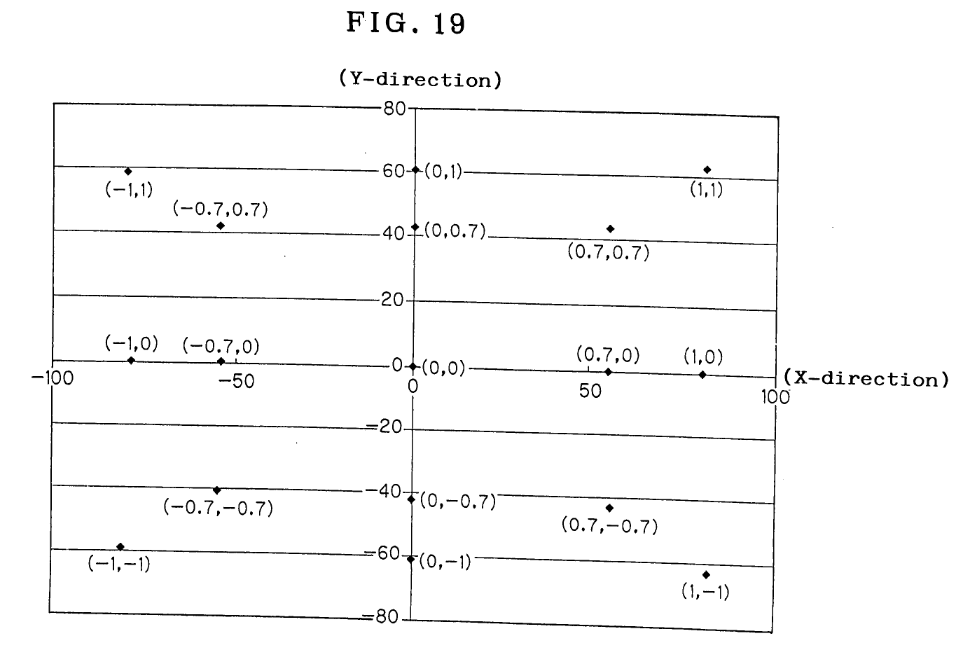

FIGS. 17, 18 and 19 are similar to FIG. 2, indicative of distortions upon scanning in Examples 1, 2 and 3.

As can be seen from what has been described, the present invention can provide a compact two-dimensional optical scanner with reduced distortions upon scanning, which is constructed using a scanning mirror of gimbal structure as well as an image display system using the same.

What we claim is:

1. A two-dimensional optical scanner, comprising in combination:
a light source,
a scanner unit for scanning a light beam from said light source on the surface to be scanned in a two-dimensional direction, and
a scanning optical system having a non-rotationally symmetric surface, wherein:
said scanner unit has a gimbal structure, and
said scanning optical system comprises a decentered prism having an entrance surface through which a light beam scanned by said scanner unit enters said prism, at least one reflecting surface for allowing a light beam entered from said entrance surface into said prism to be reflected in said prism and an exit surface through which a light beam reflected at said second reflecting surface leaves said prism, wherein at least one of said entrance surface, said reflecting surface and said exit surface comprises a non-rotationally symmetric surface.

2. The two-dimensional optical scanner according to claim 1, wherein:
said decentered prism has a first reflecting surface for allowing a light beam entered from said entrance surface into said prism to be reflected in said prism and a second reflecting surface for allowing a light beam reflected at said first reflecting surface to be reflected in said prism.

3. The two-dimensional optical scanner according to claim 1, wherein:
the respective surfaces of said decentered prism are located such that a light beam from said entrance surface toward said first reflecting surface crosses a light beam from said second reflecting surface toward said exit surface in said prism.

4. The two-dimensional optical scanner according to claim 1, wherein:
at least one surface of said decentered prism also serves as an optical surface through which light from said light source enters said scanner unit.

5. The two-dimensional optical scanner according to claim 4, wherein:
at least one surface of said decentered prism also serves as an optical surface for reflecting light from said light source toward said scanner unit.

6. The two-dimensional optical scanner according to claim 1, wherein:
said scanner unit comprises a scanning mirror,
an axial chief ray of said light beam is reflected at at least two reflecting surfaces while said axial chief ray propagates from said surface to be scanned to said scanning mirror, and
the following two conditions (1) and (2) are satisfied:
10°<Θ1<40° (1)
10°<Θ2<40° (2)
where Θ1 and Θ2 are angles that said axial chief ray subtends a normal to said at least two reflecting surfaces at positions where said axial chief ray is incident on said at least two reflecting surfaces; Θ1 is an angle that said axial chief ray subtends said normal to one of said at least two reflecting surface and Θ2 is an angle that said axial chief ray subtends said normal to the other of said at least two reflecting surfaces, provided that an axial ray is defined by a light ray that comes out of the surface to be scanned to a center of the scanning mirror.

7. The two-dimensional optical scanner according to claim 1, wherein:
said scanner unit comprises a scanning mirror, and
the following condition (3) is satisfied,
1°<Θm<45° (3)
where Θm is an angle that a given light ray subtends a normal to a surface at a position where said given light ray is incident on said surface, provided that said given light ray is defined by a light ray that propagates toward a center position of said surface to be scanned.

8. The two-dimensional optical scanner according to claim 1, wherein:
said light source is a light-emitting diode or a laser diode.

9. The two-dimensional optical scanner according to claim 1, wherein:
said light source includes at least R, G and B wavelengths.

10. The two-dimensional optical scanner according to claim 9, which further comprises an optical synthesis element for synthesizing light rays of at least R, G and B wavelengths.

11. The two-dimensional optical scanner according to claim 9, wherein:
said light source comprises at least emitting portions for emitting said light rays of R, G and B wavelengths, wherein said emitting portions are located such that said light rays of R, G and B wavelengths are mutually shifted.

12. The two-dimensional optical scanner according to claim 11, wherein:
said emitting portions are located in such a way as to have the same scan start positions.

13. The two-dimensional optical scanner according to claim 11, wherein:
said emitting portions are located in such a way as to have different scan start positions, and
modulation is performed at different timings with respect to light rays emitted out of said respective emitting portions.

14. A two-dimensional optical scanner, comprising in combination:
a light source,
a scanner unit for scanning a light beam from said light source on a surface to be scanned in a two-dimensional direction, and
a scanning optical system having a non-rotationally symmetric surface, wherein:
said scanning optical system comprises a decentered prism having at least one reflecting surface and configured into a shape in which a symmetric surface exists,
said scanning optical system is located such that said symmetric surface does substantially include the origin of a screen surface defined by a point of intersection of an optical axis of said scanning optical system with the surface to be scanned, and
said scanning optical system and said scanner unit are located such that one scanning direction is substantially in line with a direction of said symmetric surface.

15. An image display system, comprising in combination:
a light source,
a scanner unit for scanning a light beam from said light source on a surface to be scanned in a two-dimensional direction,
a scanning optical system having a non-rotationally symmetric surface, and
an eyepiece optical system located near said surface to be scanned and having positive power, wherein:
said scanner unit has a gimbal structure, and
said scanning optical system comprises a decentered prism having an entrance surface through which a light beam scanned by said scanner unit enters said prism, at least one reflecting surface allowing a light beam entered from said entrance surface into said prism to be reflected in said prism and an exit surface through which a light beam reflected at said second reflecting surface leaves said prism, wherein at least one of said entrance surface, said reflecting surface and said exit surface comprises a non-rotationally symmetric surface.

16. The image display system according to claim 15, which further comprises a diffusing surface located near said surface to be scanned and having optical diffusibility.

17. The image display system according to claim 15, wherein said diffusing surface has a property such that an angle of diffusion is 200 or smaller at full width where light intensity goes down to 1/10.

18. The image display system according to claim 16, wherein at least two such diffusing surfaces are provided.

19. The image display system according to claim 15, wherein said eyepiece optical system comprises a Fresnel lens.

20. The image display system according to claim 15, wherein said eyepiece optical system comprises a Fresnel reflecting mirror.

21. The image display system according to claim 15, wherein said eyepiece optical system comprises a Fresnel back-surface reflecting mirror.

22. The image display system according to claim 16, wherein said diffusing surface is provided on at least one surface of said eyepiece optical system.

23. The image display system according to claim 15, wherein said decentered prism further comprises a first reflecting surface for allowing a light beam entered from said entrance surface into said prism to be reflected in said prism and a second reflecting surface for allowing a light beam reflected at said first reflecting surface to be reflected in said prism.
